(19) United States
(12) Patent Application Publication
(10) Pub. No.: US 2017/0353081 A1
(43) Pub. Date: Dec. 7, 2017

(54) MULTIHULL BARGE GENERATOR

(71) Applicant: Salvatore Deiana, Vancouver (CA)

(72) Inventor: Salvatore Deiana, Vancouver (CA)

(21) Appl. No.: 15/174,317

(22) Filed: Jun. 6, 2016

(51) Int. Cl. H02K 7/18; B63B 35/44; F03B 13/00

(52) U.S. Cl. CPC H02K 7/1823; F03B 13/00; B63B 35/44; B63B 2035/4466

(57) ABSTRACT

A barge generator adapted to generate electrical power from surface currents of a body of water. The barge generator has a plurality of hull portions that form one or more tunnels along the length of the vessel. Hydrodynamic screws are received in the tunnels and coupled to an electrical generator such that water currents communicated through the tunnel impart rotational movement of the screw. A deployable curtain is extensible to funnel the currents towards the barge generator to increase the volume and velocity of water carried through the tunnel.

### BACKGROUND OF THE INVENTION

The present invention relates hydrodynamic power generation, and more particularly to an apparatus for hydrodynamic power generation from horizontal water movements.

Presently in the art, most related power generation technology on water flow dynamics was intended only for the vertical motions of sea waves. These technologies used hydraulic contractions to generate electricity. However, these technologies ignored another equally valuable hydrodynamic motion, that is, the horizontal components, such as the ones that strike shore lines and contribute to oceanic currents and tidal flows.

Some of these technologies were short lived and soon abandoned. Because they were ill conceived, some were weak and others, curiously enough, because they were excessively strong. Strength alone without flexibility provides no guarantee of survival in a significant sea storm. Rigid structures erected on shore or on the sea floor need to be floated to add the requisite flexibility for structural survival.

Strength and flexibility is the answer to a superior structure for withstanding oceanic forces. By way of example, when a docked ship in an unprotected port is informed of an approaching storm, it leaves port immediately for the open sea, where bobbing up and down, it can weather the storm and safely return to port after the storm has passed.

As can be seen, there is a need for floating multihull barges and hydrodynamic turbine screw generators operating to generate electric energy from the horizontal movements of large bodies of water, such as may be present in oceanic currents and tidal flows.

### SUMMARY OF THE INVENTION

In one aspect of the present invention, a barge generator includes a water borne vessel having a bow, a stern, and a plurality of spaced apart flotation hulls longitudinally extending between the bow and the stern. A tunnel is defined between the plurality of spaced apart flotation hulls, the tunnel having an arcuate top surface and a bottom opening. A hydrodynamic screw is disposed within the tunnel for rotational movement about a shaft operatively connected to a generator.

In other aspects of the invention, a cylindrical spool is attached to the stern of the vessel at each of an outermost starboard and a port flotation hull. An extensible curtain is contained within the cylindrical spool, wherein the curtain is configured to be selectively deployed between an extended condition and a stowed condition. The curtain may be configured with a plurality of slats attached to the curtain in a laterally spaced apart relation and the slats maintaining the curtain in a substantially vertical alignment along the longitudinal length of the curtain. A plurality of flotation devices may be attached to a top end of the curtain in a spaced apart relation along the longitudinal length of the curtain. The flotation devices are attached to a top end of the plurality of slats. A buoyant tube may be attached along a top edge of the curtain. The buoyant tube may also be an inflatable tube. To facilitate deployment, a coupling is attached at an end of the curtain for attachment to one of a tow line of a machine powered vessel, or a tethered buoy.

In other aspects of the invention, an inlet is defined as the entrance to the tunnel and an outlet is defined as the exit from the tunnel. The inlet is adapted to receive a current of a body of water for rotation of the hydrodynamic screw. The barge generator may also have a plurality of cross member tube to hold together the bottom of the hulls. The barge generator may also include a superstructure extending above a top deck of the waterborne vessel, to house the generators.

These and other features, aspects and advantages of the present invention will become better understood with reference to the following drawings,

Description and claims.

### BRIEF DESCRIPTION OF THE DRAWINGS

FIG. 1 is a front perspective view of an embodiment of a multihull barge generator.

FIG. 2 is a rear elevation view of an embodiment of a multihull barge generator.

FIG. 3 is a bottom plan view of an embodiment of a multihull barge generator.

FIG. 4 is a front elevation view of an embodiment of a multihull barge generator.

FIG. 5 is an end view of a hydrodynamic turbine screw according to aspects of the invention.

FIG. 6 is a partial side perspective view of a hydrodynamic turbine screw.

FIG. 7 is a perspective view of a multihull barge generator deployed on a surface of a body of water.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hydrodynamic turbine screw generator barge for deployment on the surface of a body of water which generates electrical power from the horizontal movement of water in the body of water.

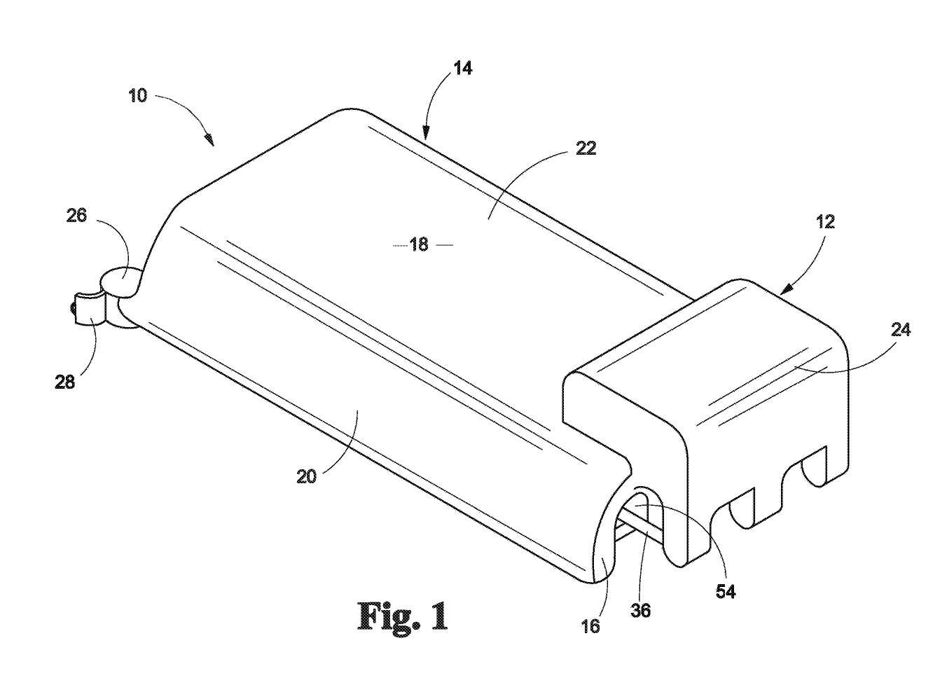

As seen in reference to FIGS. 1-3, the multihull barge generator 10 of the present invention is a water borne vessel having a bow 12, a stern 14, and a plurality of spaced apart flotation hulls 16 longitudinally extending between the bow 12 and the stern 14. A substantially flat top deck 18 may span the bow 12, the stern 14, a starboard side 20 and a port side 22. The multihull barge generator 10 may also have a superstructure 24 that extends above the top deck 18, and may be positioned at the bow 12 or the stern 14 of the vessel 10. The hulls 16 and structure of the barge 10 are susceptible to corrosion, particularly in marine environments. Accordingly, the exposed surfaces of the barge may be coated with a suitable corrosion preventative resin. Additionally, a plurality of closely spaced plastic strips may be adhered to the exposed surfaces of the barge 10.

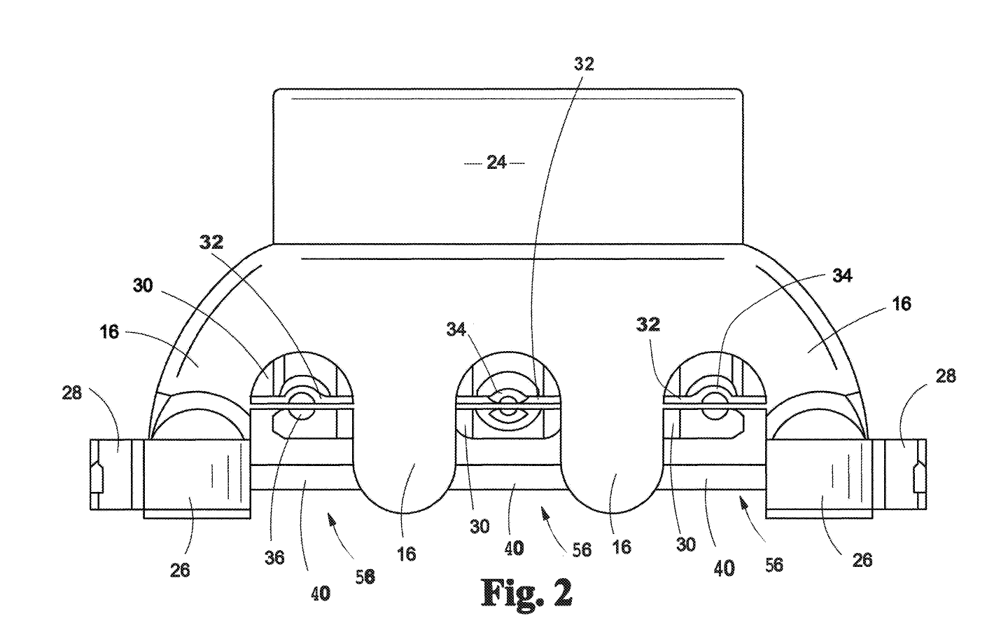

As seen in reference to FIG. 2, the stern 14 has a plurality of inlets 28 defined between the hulls 16. The plurality of inlets 28 are in fluid communication with a plurality of tunnels 30 extending along the longitudinal length of the vessel and defined between an adjacent pair of spaced apart hulls 16. The tunnels 30 have an arcuate top portion and substantially vertical sidewalls, such that a top half of the tunnels 30 are substantially cylindrical and the bottom half of the tunnels 30 are open to the body of water.

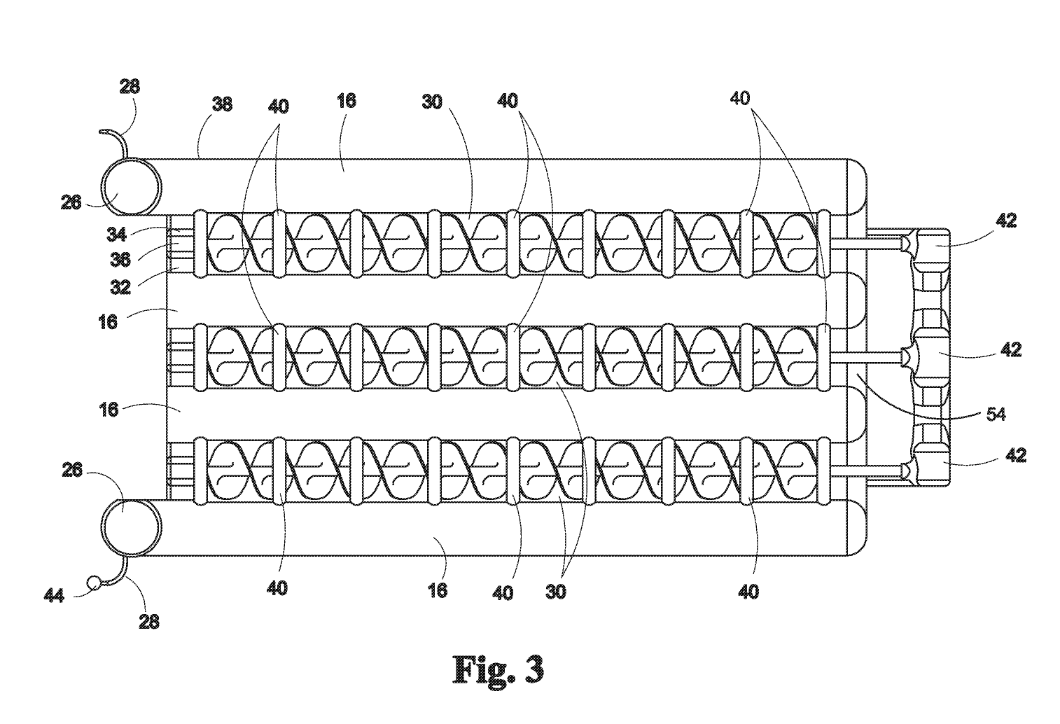

A bearing support 32 extends generally laterally between adjacent hull portions 16 and provides a mount for a bearing assembly 34 adapted to support rotational movement of a first end of a shaft 36 configured with a hydrodynamic screw 38. As best seen in reference to FIG. 3, the shaft 36 and hydrodynamic screw 38 extends within tunnels 30 along the longitudinal length of the vessel 10 to the bow of the vessel 10. A second end of the shaft 36 is adapted to be coupled to a generator 42 mounted at the bow 12 of the vessel 12. The generators 42 may be enclosed within the superstructure 24 to protect the generators 42 from the water surrounding the vessel 10.

A plurality of cross tubes 40 extend laterally between adjacent hull portions 16 in a spaced apart relation along the longitudinal length of the vessel 10. The cross tubes 40 provide added structural support to the hulls 16. The cross tubes 40 are positioned such that they are disposed below the waterline, preferably at the bottom opening of the tunnels 30. In operation, the cross tubes 40 will advantageously disrupt the flow of water below the vessel 10 and increase the flow of water through the tunnels 30 to turn the hydrodynamic screw 38.

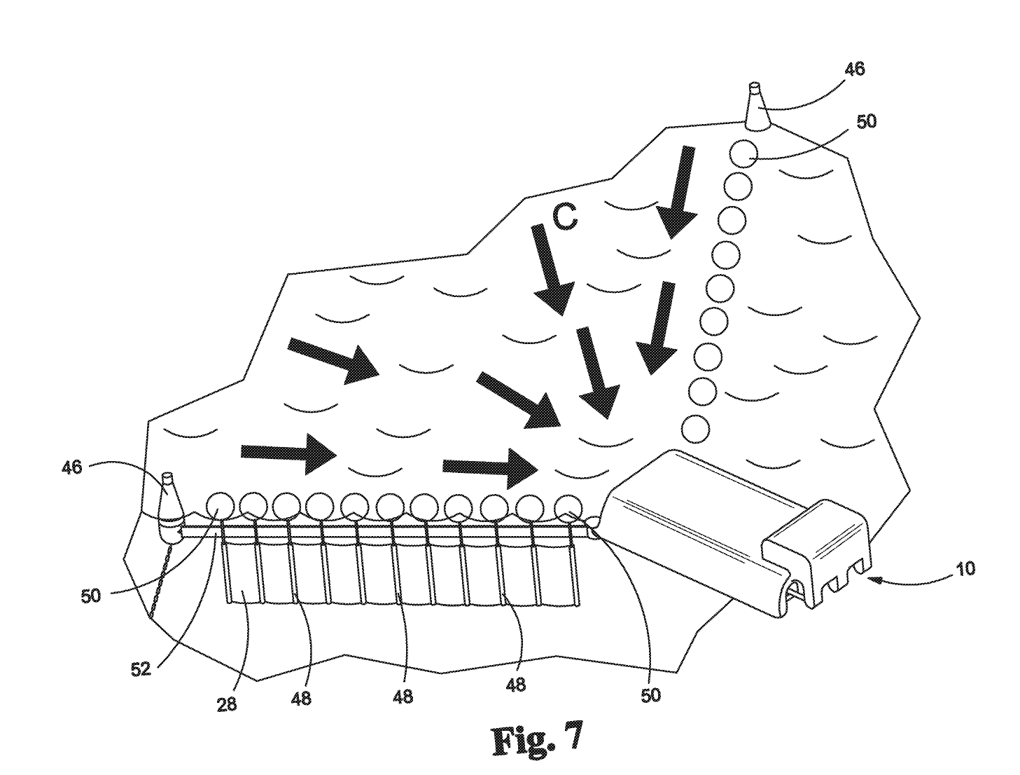

A cylindrical spool 26 is positioned at the stern of each of the outermost starboard 20 and port 22 flotation hulls 16. Each cylindrical spool 26 contains an extensible curtain 28 therein, which may be selectively deployed between an extended condition, illustrated in FIGS. 7, and a stowed condition, as seen in reference to FIGS. 1 and 2. A coupling 44 is provided at an end of the curtain 28 for attachment to a tow line of a machine powered vessel to pull the curtain 28 to its deployed condition. Once deployed, the coupling 44 may be attached to a tethered buoy 46 anchored to a floor of the body of water.

The curtain 28 may be provided with a plurality of slats 48 to provide vertical rigidity to the curtain 28. The slats 48 may be fitted with flotation devices 50 at the upper ends thereof to maintain a top end of the curtain 28 generally level with the surface of the water. The configuration of the curtain 28, slats 48, and flotation devices 50 provides freedom of movement for the curtain 28 to displace with the diversity of waves impacting the curtain 28 at different locales along its deployed length. Alternatively, or in addition to the flotation devices 50, a top edge of the curtain 28 may be fitted with a flexible buoyant tube 52, which may be an inflatable tube 52.

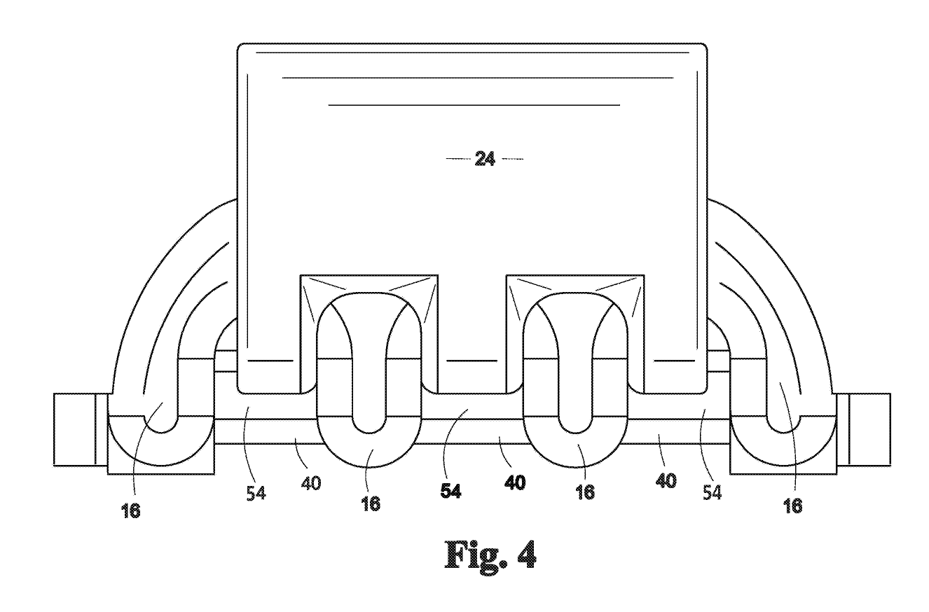

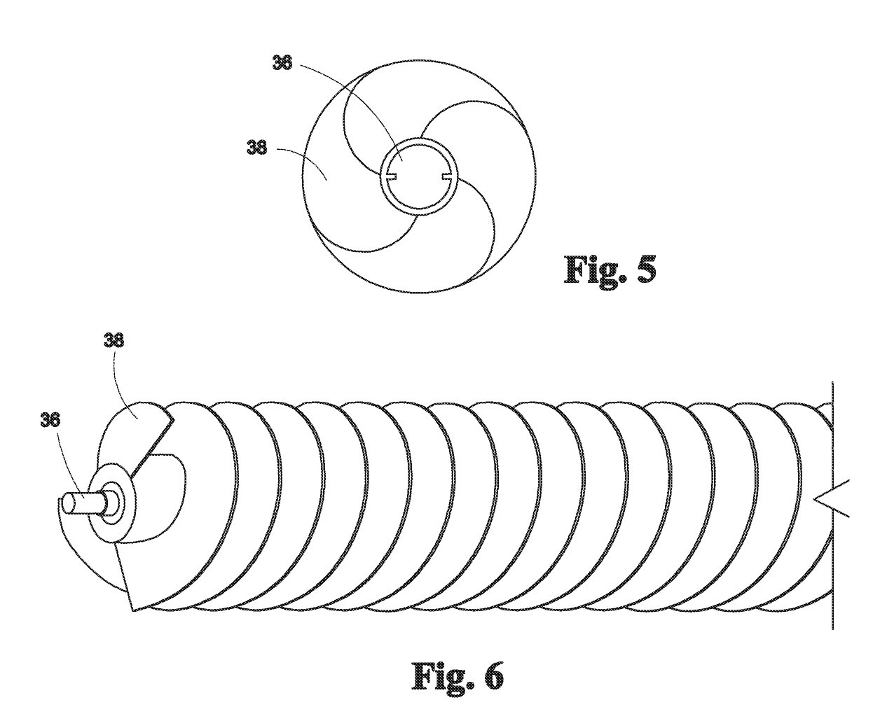

As seen in reference to FIG. 4, an outlet 54 of the tunnels 30 opens to the bow 12 of the vessel 10 to discharge the water carried through the tunnels 30 and turning the hydrodynamic screws.

The multihulls generator 10 is configured and deployed to capture sea motion, which is greater on the surface and continually diminishes as depths increase and reaches a point where it stops completely. The Multihulls barge generator 10 is deployed to target the top surface of a body of water, where water motion is most active in order to harness the energy. Marine currents, tidal currents and others currents have low energy level and as such have no economic value some people say.

Marine currents and tidal currents may be harnessed by deployment of the curtains 28 connected to the multihulls generator 10 so as to effectively dam the sea surface. According to aspects of the invention, the velocity of the currents may be increased in different methods as follows:

On the rear of the multihulls barge 10 are two cylinders 26 containing a narrow but lengthy curtain 28 made up of strong materials. As curtains 28 are deployed, weights, or slats 48 and floaters 50 are configured so as to keep the curtain 28 standing vertically. Once deployed, the curtains 28 may be secured in place by attachment to the buoy 46 which is anchored to the floor of the body of water. The curtains 28 will engulf an ever expanding water spectrum until they reach and tied up to at least two laterally displaced anchoring buoys 46.

This wide sequestered area will funnel the current C into the narrow tunnels 30 formed in the longitudinal length of the multihulls barge 10 exerting a force on the hydrodynamic screw 38. Upon entering the tunnels 30 the water will also speed increase, as a Venturi Effect, as when a river speeds up in a narrow gorge and to increase water's speed yet more the solution is to restrict the water flow even more. In a river, a gorge is constricted by rock or concrete formations, which increase resistance will speed up the water flow. The same effect is achieved in a multihulls barge 10 by using cross tubes 40 disposed along the bottom opening of the tunnels 301. This additional resistance will cause increased speed and thus improve the performance of the hydrodynamic screw 38, via a secondary Venturi Effect.

By positioning a number of hydrodynamic screws 38 and the number of barge tunnels 30 an increased resistance to the flow will be imparted to cause another increase on the current speed, a third Venturi Effect.

The economic benefits are also important for they lower the generator cost of operation. By way of example, if the barge 10 is operated in the Gulf Stream, a huge barge operator could also rent out empty space on the upper deck 18 of the barge 10 for rescue operations, a communication center, marine policing, and marine research. The barge 10 could also become a dock and supply center for navigators, cruise ship and, because of its size, could also be configured as a sea hotel.

If deployed to operate in the Arctic and Antarctic currents the barge 10 would become in very high demand for data storage centers, whose requirements are cold temperatures. Interested parties would be internet service providers, could storage companies, municipalities, government agency, private and international institute looking for a cheap place to store data safely and cheaply. Data storage is indifferent a particular GPS location and marine real estate is larger and cheaper that on shore.

For power generation on inland waterways, such as rivers and streams, the multihull vessel may be dimensioned to float on the body of water. Because the vessel would not obstruct the body of water, as would a hydroelectric dam, the vessel of the present invention offers a more environmentally friendly source of renewable energy from these inland waterways, without disrupting the natural water flow or disturbing the course of the waterway.

It should be understood, of course, that the foregoing relates to exemplary embodiments of the invention and that modifications may be made without departing from the spirit and scope of the invention as set forth in the following claims.

What is claimed is:

1. A barge generator, comprising:
a water borne vessel having a bow, a stern, and a plurality of spaced apart flotation hulls longitudinally extending between the bow and the stern;
a tunnel defined between the plurality of spaced apart flotation hulls, the tunnel having an arcuate top surface and a bottom opening;
a hydrodynamic screw disposed within the tunnel for rotational movement about a shaft operatively connected to a generator at a first end of the water borne vessel.

2. The barge generator of claim 1, further comprising:
a cylindrical spool attached to the stern at each of an outermost starboard and a port flotation hull.

3. The barge generator of claim 2, further comprising:
an extensible curtain contained within the cylindrical spool, wherein the curtain is configured to be selectively deployed between an extended condition and a stowed condition.

4. The barge generator of claim 3, further comprising:
a plurality of slats attached to the curtain in a laterally spaced apart relation and configured to maintain the curtain in a substantially vertical alignment along the longitudinal length of the curtain.

5. The barge generator of claim 4, further comprising:
a plurality of flotation devices attached to a top end of the curtain in a spaced apart relation along the longitudinal length of the curtain.

6. The barge generator of claim 5, wherein the flotation devices are attached to a top end of the plurality of slats.

7. The barge generator of claim 4, further comprising:
a buoyant tube attached along a top edge of the curtain.

8. The barge generator of claim 7, wherein the buoyant tube is inflatable.

9. The barge generator of claim 4, further comprising:
a coupling attached at an end of the curtain for attachment to one of a tow line of a machine powered vessel, or a tethered buoy.

10. The barge generator of claim 1, further comprising:
an inlet defined at a first of the tunnel and an outlet defined at a second end of the tunnel, the inlet adapted to receive a current of a body of water for rotation of the hydrodynamic screw.

11. The barge generator of claim 10, further comprising:
a plurality of cross tubes laterally extending between adjacent flotation hulls proximal to the bottom opening of the tunnel.

12. The barge generator of claim 11, further comprising:
a superstructure extending above a top deck of the waterborne vessel, the superstructure enclosing the generator.

13. The barge generator of claim 12, further comprising:
a resin coating applied to an exposed surface of the barge.

14. The barge generator of claim 13, further comprising:
a cladding layer formed from a plurality of closely spaced plastic strips adhered to the exposed surfaces.
